(19) United States
(12) Patent Application Publication
(10) Pub. No.: US 2026/0072775 A1
(43) Pub. Date: Mar. 12, 2026

(54) SEMI-STATIC ERROR BANK ARCHITECTURE IN INTEGRATED CIRCUITS

(71) Applicant: SiFive, Inc., Santa Clara, CA (US)

(72) Inventor: Jon Stephan, Boston, MA (US)

(73) Assignee: SiFive, Inc., Santa Clara, CA (US)

(21) Appl. No.: 18/883,554

(22) Filed: Sep. 12, 2024

(51) Int. Cl. G06F 11/07

(52) U.S. Cl. CPC G06F 11/0787; G06F 11/0709

(57) ABSTRACT

The present application relates to devices and components including apparatus, systems, and methods for measurements for serving cell configuration.

### TECHNICAL FIELD

This application relates generally to communication networks and, in particular, to measurements for serving cell configuration.

### BACKGROUND

Reliability, availability, and serviceability (RAS) are used in a computer system to enable the system to operate continuously and correctly, reduce downtime, and simplify maintenance and repair. Reliability may refer to the system's ability to operate without failure over a specified period, which may involve designing systems to handle and recover from faults and provide data integrity and consistent performance. Availability may measure the system's readiness for use, often expressed as an uptime percentage. High-availability systems are designed with redundancy, failover mechanisms, or robust error handling. Serviceability may address the ease with which a system can be maintained, repaired, and upgraded, including features such as simplified diagnostics, error reporting, and component replacement.

RAS may include incorporating error-detection techniques. Computer systems may use error detection techniques such as error-correcting code (ECC) memory and parity checks to detect and correct data errors. In some instances, ECC may correct single-bit errors and detect multi-bit errors. Other ECCs may be able to correct more than one error. For example, a computer server CPU may include built-in ECC for its cache memory to detect and correct errors, preventing some data corruption or system crashes.

### BRIEF DESCRIPTION OF THE DRAWINGS

FIG. 1 illustrates a compute system in accordance with some embodiments.

FIG. 2 illustrates a block diagram of an error bank in accordance with some embodiments.

FIG. 3 illustrates a block diagram of aspects of an error bank in accordance with some embodiments.

FIG. 4 illustrates a timing diagram in accordance with some embodiments.

FIG. 5 illustrates a flow diagram in accordance with some embodiments.

FIG. 6 illustrates a block diagram of an example of a multi-chip package in accordance with some embodiments.

FIG. 7 illustrates a block diagram of an example of a computing system in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

RAS error-record register interface (RERI) specification (e.g., RISC-V RERI Architecture Specification, RERI Task Group, Version v1.0, 2024-05-24:Ratified) may specify error bank registers. RERI may incorporate storage (e.g., register or memory) for error recording. Error recording may use registers or logs to capture and manage error data. The registers are used to store detailed error information, which can be accessed for diagnosing, maintenance, or implementing corrective actions.

Once an error is detected, the system logs the error information into a predefined storage, e.g., register or log files. The error log may include details such as the error type, severity, affected component, timestamp, and other additional context that may help in diagnosing. In some examples, errors may be recorded in system event logs that are accessible by the operating system and diagnostic tools.

Several entities may access and retrieve error records. In some examples, firmware or basic input/output systems (BIOS) may check error logs during system startup and report any critical errors. In some examples, the operating system (OS) may regularly check hardware error logs and system event logs. Diagnostic tools and utilities within the OS may retrieve and present this information to system administrators or automated monitoring tools. Specialized diagnostic software may access error registers and system logs to provide detailed reports. These tools may include features for analyzing error patterns, predicting potential failures, or suggesting corrective actions. In some instances, remote monitoring tools may aggregate error data from multiple systems, allowing centralized management.

RAS technical specifications outline requirements for error reporting. For instance, to be compliant with RAS technical specifications, error records are statically allocated. Each error record can be associated with a hardware component, such as registers, caches, memory modules, logic circuits, or other structures within an integrated circuit (IC). However, a key limitation of static allocation under RAS specifications is the inability to log multiple errors associated with the same hardware structure.

To address the limitations of static allocation as per RAS specifications, a computing system may implement a semi-static storage allocation method for recording error events. During write operations and error event logging, these events are stored dynamically in a dynamic storage area. Additionally, the system can configure static storage for one or more error records, with each error record linked to a specific hardware structure. This static storage remains compliant with RAS technical specifications.

An association is established between error entries in the dynamic storage and error records in the static storage. This association is typically based on the corresponding hardware structure. Multiple error entries related to a single hardware component can be stored in the dynamic storage. Concurrently, a static error record for the same hardware structure can be configured in the static storage. When creating or logging each error entry, a field in the static error record can be set to link it to the corresponding dynamic error entry. For example, a field in the static error record might store the address of the related error entry in the dynamic memory.

To retrieve error records, software or an entity can read the content of the static error record stored in the static storage. This error record provides common information for all entries and error events. Additionally, it can retrieve detailed information from the associated error entries stored in the dynamic storage.

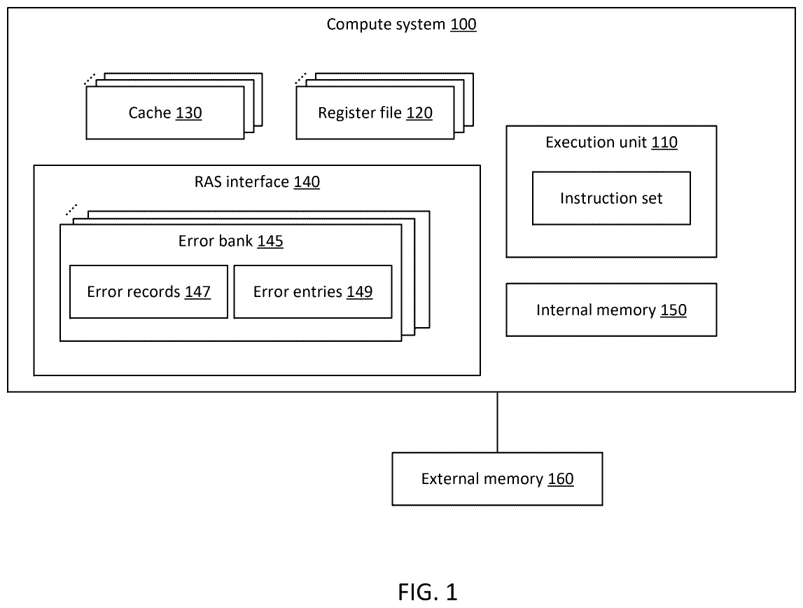

FIG. 1 illustrates a compute system 100 in accordance with some embodiments. Compute System 100 may include a combination of hardware and software designed to perform computational tasks. Compute system 100 may be a central processing unit (CPU) with one or more cores, maybe a core within a CPU, a special-purpose computer designed for a specific task (e.g., an accelerator or digital signal processing (DSP)), or a graphics processing unit (GPU) with one or more cores.

Compute system 100 may include an execution unit 110. Execution unit 110 may perform operations specified by the instructions, such as arithmetic calculations, logical operations, and data manipulation tasks. The instruction set may be a collection of instructions that compute system 100 can execute. The instruction set may determine how data is processed, manipulated, and transferred within the system. The instruction set architecture (ISA) may define the operations, data types, registers, addressing modes, and memory architecture that the execution unit can utilize.

Compute system 100 may be a complex instruction set computing (CISC) system. CISC architectures (e.g., instructions used in traditional ×86 processors) may be designed to execute complex instructions that can perform multiple operations. Each instruction in a CISC architecture may execute several low-level operations, such as memory access, arithmetic operations, and branching, in a single instruction cycle. The complex instructions may reduce the number of instructions per program but may increase execution time.

Compute system 100 may be a reduced instruction set (RISC) system. RISC architectures, e.g., such as those used in ARM processors, may focus on a smaller set of simple instructions. Each instruction may designed to execute in a single clock cycle, which can lead to faster and simpler (compared to CISC instructions) execution. RISC architectures may emphasize high performance and energy efficiency, making them suitable for mobile and embedded systems.

Compute system 100 may be a very long instruction word (VLIW) system. VLIW architectures may bundle multiple operations into a single long instruction word, allowing execution unit 110 to execute multiple operations in parallel.

Compute system 100 may be a single instruction, multiple data (SIMD) system. SIMD architectures may be used in GPUs, allowing a single instruction to operate on multiple data points simultaneously. The parallel operation on multiple data points may be beneficial in operations such as graphics rendering or tasks where the same operation is applied to larger datasets.

Execution unit 110 may include an arithmetic logic unit (ALU), floating point unit (FPU), integer unit, load/store unit, or a branch unit. The ALU may perform arithmetic operations such as addition, subtraction, multiplication, or division. ALU may also perform logical operations such as AND, OR, NOT, and XOR. The FPU may be specialized to perform floating-point arithmetic operations. Similarly, integer unit may handle integer arithmetic and logical operations. The load/store unit may manage data transfer between the execution unit 110 and the memory hierarchy, e.g., register files 120, cache 130, internal memory 150, or external memory 160. Load/store unit may handle fetching data from registers and storing data from registers back into memory (e.g., internal memory 150 or external memory 160). The branch unit may process branch instruction, altering the flow of execution based on conditions. The branch unit may evaluate conditions and determine the next instruction to execute.

Compute system 100 may include one or more register files, e.g., register file 120. Register files, e.g., register file 120, may store data such as integers, floating-point numbers, addresses, or control information. Each register in the file is identified by a unique address or index, allowing compute system 100 to read from or write to specific registers as needed.

Register file 120 may be a general purpose register (GPR). GPRs may be used for tasks such as arithmetic operations, logical operations, or data movement. GPRs can store any type of data used by compute system 100. In one example, in an x86 architecture, registers like EAX, EBX, ECX, and EDX are examples of general-purpose registers.

Register file 120 may be a floating-point register (FPR). FPRs may be used to hold floating-point numbers and perform floating-point arithmetic operations. FPRs may be used by applications associated with high precision and complex mathematical calculations, such as scientific computing and graphics rendering.

Register file 120 may be a special-purpose register (SPR). In one example, an SPR may be an instruction pointer used to keep track of the address of an instruction, e.g., the next instruction to be executed. In one example, an SPR may be a status register holding flags representing the state of the compute system 100, such as the Zero Flag or Carry Flag, used in conditional operations and branching.

Register file 120 may be a vector register. Vector registers may hold multiple values, enabling the parallel processing of data. In one example, vector registers are used by multimedia applications.

Register file 120 may be a control and status register. Control and status registers may store control and status information governing the operation of the compute system 110. For example, control and status registers may include program status words, control flags, or configuration settings.

Compute system 110 may include one or more caches, e.g., cache 130. Cache 130 may be a level 1 (L1) cache. L1 cache 130 may be designed to store frequently accessed data and instructions to speed up the execution of programs by reducing the time needed to fetch data or instructions from the external memory 160. L1 cache 130 may be an instruction cache (L1I) or data cache (L1D). Instruction cache may store instructions that compute system 100 is likely to execute. During running a program, compute system 100 may fetch instructions from the L1 instruction cache. L1 data cache may store data that compute system 100 needs to access, e.g., operands from arithmetic and logic operations, intermediate results, or data that compute system 100 frequently reads or writes. In one example, Cache 130 may be a level 2 (L2) or a level 3 (L3) cache.

Compute system 100 may be communicatively coupled with internal memory 150 or external memory 160. Internal memory 150 may be an embedded memory or an on-die memory, such as high-bandwidth memory (HBM). External memory 160 may be a volatile or non-volatile memory used to store data or instructions. In one example, the volatile memory may be a random access memory (RAM). RAM may be based on dynamic RAM (DRAM) technology or static RAM (SRAM) technology. External memory 160 may be a persistent storage such as a hard disk drive (HDD) or a solid-state drive (SSD).

Compute system 100 may include RAS interface 140. RAS interface 140 may include mechanisms and protocols allowing compute system 100 to monitor, detect, log, and manage hardware and software errors and faults.

RAS interface 140 may include hardware and software components to perform error detection. Hardware components such as compute system 100, register file 120, cache 130, execution unit 110, internal memory 150, or external memory 160 may be equipped with sensors and monitors that detect errors, such as parity errors, ECC errors, or thermal anomalies. Additionally or alternatively, embedded firmware and microcode with hardware components may detect and report errors.

RAS interface 140 may include hardware and software components to perform error logging, e.g., error bank 145. Error bank 145 may include a structured collection of error records 147. Error bank 145 may be designed to store detailed information about detected errors in error records 147 (error records 147 may hold a single error record). RAS interface 140 may include one or more error banks similar to error bank 145.

Error bank 145 may hold different types of error information detected by the RAS interface 140, compute system 100, or other components (not depicted) such as OS. Error bank 145 may provide a centralized location for logging errors from different components of compute system 100, such as memory modules (e.g., register files, caches, execution unit 110, internal memory 150) or input/output (I/O) devices (e.g., external memory 160).

Error records 147 may include multiple records and each error record is associated with one or more error registers. Each error record may be designed to store a specific type of error information. Each error record may include details such as the type of error, the severity, the location (e.g., memory address, core, cache 130, register file 120, etc.), or the timestamp.

In one example, one error record of error records 147 may store single-bit errors detected and corrected by the ECC mechanism. In one example, one error record of error records 147 may store multi-bit errors. Mult-bit errors may be uncorrectable errors, and the error record may indicate that the multi-bit error is uncorrectable. In one example, one error record of error records 147 may store parity errors detected in data transmission or storage (e.g., register file 130, such as integer or floating point register files, or L1 cache 130). In another example, one error record of error records 147 may indicate overheating or temperature anomalies. In another example, one error record of error records 147 may indicate a power supply error.

In legacy systems, the error records of the error bank may use certain registers, memory, or storage that are statically provisioned. For example, a fixed number of registers, say N1 registers or register groups, are allocated for records. Each register or register group may be assigned to an error type. In one example, each register or register group is allocated to a distinct error type. Thus, such a legacy system can only support N1 error types, and only a single error event can be recorded for each error type. For example, if two error events are associated with L1D, only one of them is recorded, and information about the other error event is lost. In some implementations, there can be as many register or register groups as there are hardware structures (e.g., register files, caches, logics, execution units, etc.). Each record may keep one error event associated with the corresponding hardware structure.

The restriction on static allocation for records may be imposed by industry standards such as RAS technical specifications (TSs). It is advantageous for compute system 100 to be compliant with industry standards and capture multiple error events of one type when they occur.

In one embodiment, one or more static records are allocated statically. Each record in the one or more static records may be associated with an error type. For example, one record may be associated with a detected parity error in an integer register file or another record allocated to a detected error in the L1D cache where the error was corrected with the ECC. The static record may be compliant with RAS TSs.

In some embodiments, error bank 145 of the compute system 100 may also include error entries 149, internal storage for dynamically storing error entries. Each error entry may be associated with a detected error event in compute system 100. For example, an error event such as a detected parity error in an integer register file is an error event. The information associated with the error event, such as timestamp, hardware structure identification, severity of the error event, error type information, or other information, may be stored in an error entry of the error bank 145.

Each error entry in error entries 149 may have two associations: 1) an association with the error event and 2) an association with the static error record 147 corresponding to the error type of the associated error event. For example, an error entry may include information related to the error type of the error event, e.g., a register for storing an indication of the error type. Additionally, the error entry may include an indication of the error record corresponding to the error type. In one example, information on the error type stored in the error entry may determine the corresponding error record 147. In another example, an error entry may include a register for storing the address of the static record corresponding to the static record associated with the detected parity error in an integer register file.

In one example, a first error event associated with a given error type (e.g., a detected parity error in an integer register file) is stored in the first available location in the error entries 149. The error entry is associated with a static error record for the given error type in error records 147. A second error event associated with the same error type can also be stored in the next available location in error entries 149. The new error entry is also associated with the same static error record as the error entry for the first error event.

In some embodiments, software or hardware may retrieve or access an error record in error records 147. Error bank 145 may determine all the error entries in error entries 149 that are associated with the selected error record and provide the information to the requesting software or hardware entity.

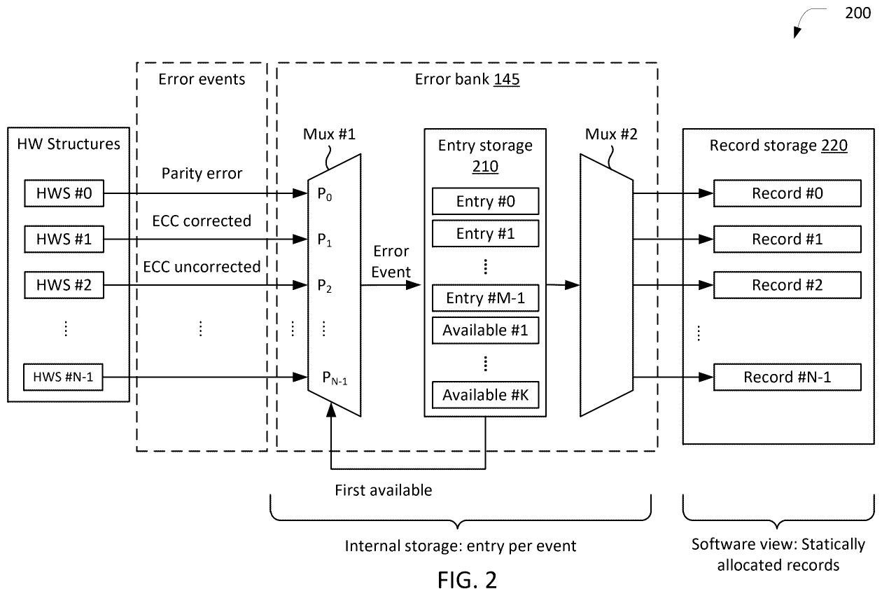

FIG. 2 illustrates a block diagram 200 of an error recording system in accordance with some embodiments. Block diagram 200 may include one or more hardware structures. By way of example and not limitation, a HW structure may include, among other things, one or more register files (RFs) (e.g., register file 120, integer or floating point RFs), one or more caches (e.g., cache 130, L1D, L1I, L2, or L3 caches), internal or external memories (e.g., memories 150 or 160), or one or more logics with hardware (e.g., circuitry) or software (e.g., firmware) components (e.g., execution unit 110, memory controller, microcontroller, etc.). In one example, compute system 100 may include N hardware structures, e.g., HWS #0-N-1.

RAS interface 140 or other components local to each HW structure may monitor and detect errors. Errors may be categorized into different error types. For example, one error type may be a parity error. A parity error may be detected when the parity bit(s) does not align with the data bits according to the predefined parity scheme (e.g., even or odd parity schemes). The error may indicate that data has been corrupted (e.g., during transmission or storage). Memory systems such as RAM or register files, such as integer or floating-point register files, may implement parity bits. The parity bit is calculated based on the data and stored alongside the data. The parity bit is checked to ensure data integrity when the data is read or accessed.

In some examples, e.g., in L1 cache or memory, compute system 100 may apply ECC to stored data. Using ECC, A bits of data may be encoded into B bits of coded data, where B>A. Coded data is stored, e.g., in memory, register files, or L1 cache. In some examples, the system bus may apply ECC to detect and correct errors when data is transferred between the compute system 100 or its components or other components or peripherals, e.g., external memory. The decoder may detect an ECC error. One error type may be detecting an ECC error that is corrected by the decoder. Another error type may be detecting an ECC error that was not corrected by the decoder.

Error detection module (a module may include hardware circuitry, including analog or digital circuitry or software components such as firmware or executable code) may be part of the HW structure (e.g., HWS #0-N-1) or may be separate from the HW structure. For example, the encoder and decoder may be part of the memory or cache subsystem, or memory and cache may share and use a common encoder or decoder module, or accelerator.

HW structures (e.g., HWS #0-N-1) may be communicatively coupled with the error bank. Once the error bank receives an error event associated with a hardware structure, an entry associated with the error event may be stored in an available location in the entry storage 210.

Error bank may include Mux #1, entry storage 210, or Mux #2. Mux #1 selects one of several input signals and forwards the selected input to a single output line. Mux #1 may receive multiple lines for carrying error events and associated information. Each line may be associated with a HW structure. For example, HWS #0 may be connected to or coupled with P₀, HWS #1 to P₁, and . . . HWS #N-1 to P_{N-1} inputs of Mux #1.

Mux #1 may select the error event and deliver it to the entry storage 210. Entry storage 210 may store the error event and associated information in an available location, e.g., any of Available #1-K. The entry storage may store M entries, e.g., Entry #0-M-1. In one example, the error bank may store the error event in the next available location, e.g., Available #1. The size or capacity of the entry storage may be fixed, e.g., L entries. For example, in FIG. 2, the entry storage has the capacity of L=M+K entries.

Entry storage 210 may be internal storage in compute system 100. For example, entry storage 210 may be a portion of the internal memory 150. Each error entry may occupy one or more words or lines in the internal memory 150. In another example, entry storage 210 may be a group of dedicated registers. Each entry may occupy one or more registers.

Mux #2 may connect the entry to a record in the record storage 220. For example, Entry #0 may be associated with HWS #1, and Record #1 may be associated with the HWS #1. When an entity (software or hardware) accesses Record #1 to read the error report associated with HWS #1, MUX #2 may be used to retrieve the information stored in entry storage 210 at Entry #0.

Record storage 220 may be internal storage in compute system 100 or may be external. For example, record storage 220 may be a portion of the internal memory 150. Each error record may occupy one or more words or lines in the internal memory 150. In another example, record storage 210 may be a group of dedicated registers. Each record may occupy one or more registers. In another example, record storage 220 may be a portion of the external memory 160.

In one example, the number of records is the same as the number of HW structures. Each HW structure, e.g., one of HWS #0-N-1, may be associated with an error record, e.g., an error record of Record #0-N-1.

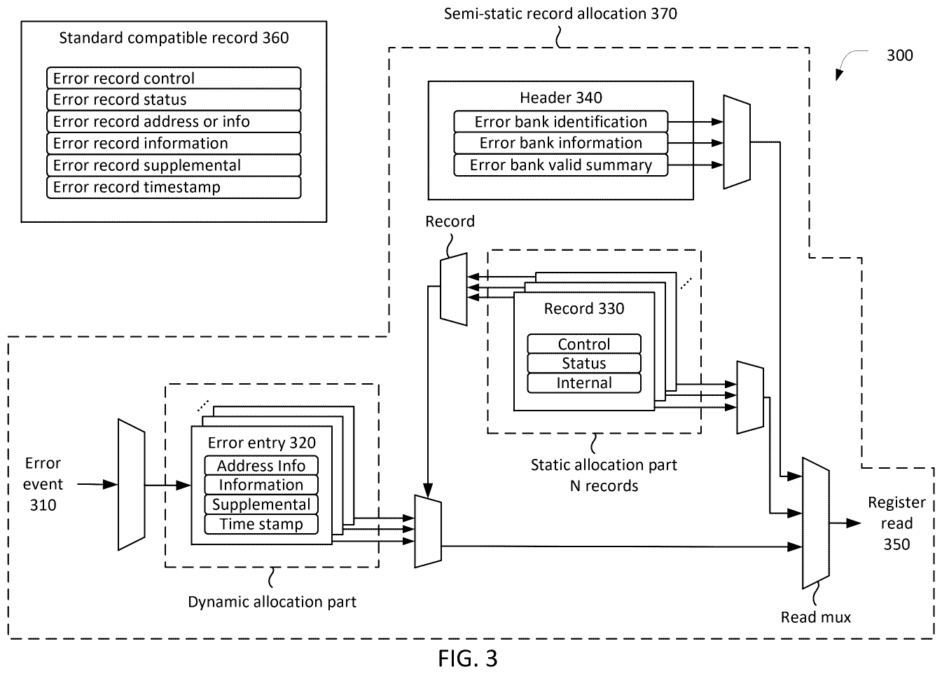

FIG. 3 illustrates a block diagram 300 of aspects of an error bank in accordance with some embodiments. Block diagram 300 illustrates dynamic and static allocation parts of a semi-static record allocation 370.

Block diagram 300 also illustrates a standard compatible record 360 that includes several fields in accordance with industry standards such as those described in RAS TSs. One field in the standard compatible record 360 may be the error record control field. Error record control field may be used to identify error code. It may include flags or control bits that indicate the type of error, whether the error has been acknowledged, or if any corrective actions have been initiated.

Standard compatible record 360 may include an error record status. The status field or register may hold the current status of the error, whether the error is active or has been resolved, or if there are ongoing actions related to the error. The error record status may indicate whether an error associated with the corresponding HW structure has occurred.

Standard compatible record 360 may include the address or information field indicating where the error occurred. This field may identify the hostname or Internet Protocol (IP) address, process identifier (ID), or error sources.

Standard compatible record 360 may include an error record information field. This field may detail information about the error, such as the source or nature of the error. It may contain an error message, error code, or error context information.

Standard compatible record 360 may include a supplemental field. Supplemental field may provide information such as stack traces, system actions, or user actions.

Standard compatible record 360 may include an error record timestamp. This field may indicate when the error occurred.

In a semi-static allocation, the required fields of a standard compatible record 360 may be distributed between record 330 (statically allocated) and error entry 320 (dynamically allocated). For example, record 330 may include a control field (e.g., similar to the error record control of the standard compatible record 360) and a status field (e.g., similar to the error record status of standard compatible record 360). Error entry 320 may include the address and information field (e.g., similar to the error record address or information field of standard compatible record 360) and the information field (e.g., similar to the error record information field). Error entry 320 may include the supplemental field (e.g., similar to the error record supplemental field of standard compatible record 360).

When compute system 100 detects an error, it may generate an error event 310 and store it in the error bank 145. The process of storing the error even 310 may referred to as a write operation. The dynamic allocation part may identify an available location in internal storage and create and store error entry 320 based on the error event 310. Error entry 320 may include one or more fields compatible with the standard compatible record 360.

Error event 310 may include information indicating the hardware structure associated with the error event, which may be used to identify record 330 in the static allocation part of the semi-static record allocation 370. Record 330 may include an internal field. The write operation may configure the internal field to indicate the address of the error entry 320, thereby creating an association between record 330 and error entry 320. The remaining fields in record 330, e.g., control or status fields, are created and set based on the information associated with error event 310. The fields in record 330 may be in compliance with standard compatible record 360 fields.

In some embodiments, the internal field of each record (e.g., record 330) may include one or more subfields. One subfield may be an access in progress (AIP) indicating whether a read operation is accessing the record. One subfield may be an entry in progress (EIP) indicating the address of the error entry (e.g., error entry 320). One subfield may be a validity field.

An entity, e.g., software, an operator, or a hardware device, may initiate retrieving error records of a hardware structure through a read operation. The read operation may obtain error record information through register read 350. In some instances, to be standard compatible, the read operation should obtain all the information in standard compatible record 360 by accessing a static location of the error record.

The read operation may determine the static allocation part of records through header 340. Header 340 may include error bank identification fields to identify the location of the static allocation part (e.g., starting register address or starting location in memory). The error bank information field of header 340 may determine the number of records in the error bank and other information associated with the error bank. Error bank validity summary may include information indicating whether the error bank is active and contains error records.

The read operation may determine a record in the static allocation part, e.g., record 330. In one example, the read operation may indicate a hardware structure. It may identify the record 330 based on the association between the record 330 and the indicated hardware structure. Identifying and accessing record 330 in the static allocation part may be compatible with RAS TSs. In another example, the read operation may iteratively read all records in the static allocation part, including record 330.

Accessing record 330, read operation may obtain the control and status field (compatible with corresponding fields in standard compatible record 360). For example, the multiplex settings may provide the content of control and status fields to register read 350.

Read operation may obtain the internal field. The EIP field of the internal field may determine the location of entry 320. The validity field of the internal field may determine whether an error entry associated with record 330 is available in the dynamic allocation part.

In one example, the value of the validity field in the internal field of record 330 may indicate whether an error event associated with the hardware structure of record 330 is available. For example, when an error entry 320 is created during the write operation, the validity field in the internal field of record 330 is also set to indicate that an error event is recorded for the corresponding hardware structure.

The EIP field of the internal field of record 330 may determine the location of error entry 320. The read operation may obtain the remaining error record fields stored in error entry 320, e.g., address information field, information field, supplemental field, and timestamp field, through register read 350 and based on the internal field of record 330. For example, the EIP field of the internal field of record 330 may configure one or more multiplexers to connect error entry 320 to register read 350, allowing delivery of the content of error entry 320 to register read 350.

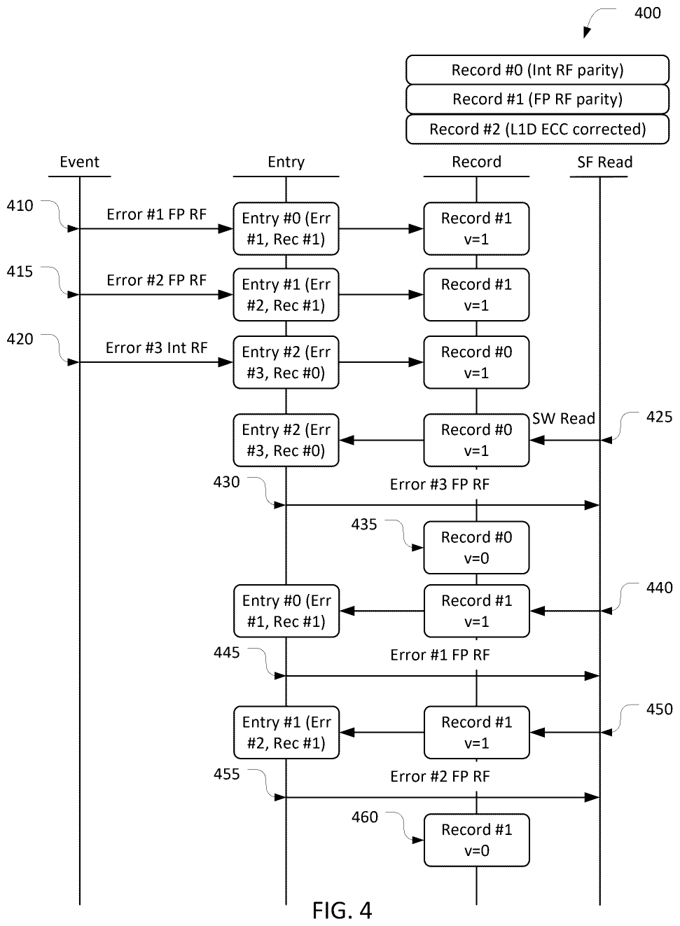

FIG. 4 illustrates a timing diagram 400 in accordance with some embodiments. Timing diagram 400 illustrates an example, including write operations to create error records in a semi-static allocation error bank and read operations to retrieve the error records. In the static part, there are three records, Record #0-2. Record #0 is associated with parity error events associated with integer register files. Record #1 is associated with parity error events associated with floating point register files, and Record #2 is associated with corrected ECC errors associated with L1D.

At 410, Error #1 is detected. Error #1 is a parity error associated with a floating point register file. The write operation determines an available location in the dynamic part (e.g., the internal memory) and creates and stores Entry #0. Entry #0 includes one or more information fields of the error record.

The write operation may determine Record #1 associated with the floating point register files and establish an association between Entry #0 and Record #1. For example, the value of the EIP field of the internal field of Record #1 is set with the address of Entry #0. Write operation may also configure the validity field of the internal field of Record #1 to indicate that an error event associated with the floating point register files is available. For example, the value of a validity field may be set to ‘1’ to indicate that an error event is available.

In one example, the validity field may be more than one bit. Each write operation associated with the record may increment the validity field's value, and the validity field's value may indicate the number of error events or error entries.

At 415, Error #2 is detected. Error #2 is a parity error associated with a floating point register file. The write operation determines an available location in the dynamic part (e.g., the internal memory) and creates and stores Entry #1. Entry #1 includes one or more information fields of the error record.

The write operation may determine Record #2 associated with the floating point register files and establish an association between Entry #1 and Record #1. For example, the value of the EIP field of the internal field of Record #1 is set with the address of Entry #1. In one example, the EIP field of the internal field of Entry #1 may be appended with the address of Entry #1 such that it contains addresses of both Entry #0 and Entry #1. Write operation may update the validity field of the internal field of Record #1.

At 420, Error #3 is detected. Error #3 is a parity error associated with an integer register file. The write operation determines an available location in the dynamic part (e.g., the internal memory) and creates and stores Entry #2. Entry #2 includes one or more information fields of the error record.

The write operation may determine Record #0 associated with the integer register files and establish an association between Entry #3 and Record #0. For example, the value of the EIP field of the internal field of Record #0 is set with the address of Entry #3.

At 452, a read operation is initiated. A software entity accesses Record #0 to obtain error records associated with integer register files. Record #0 may provide error records stored at the static location of Record #0 associated with Error #3. The validity field of the internal field may determine that an error event is recorded associated with integer register files. The EIP field of the internal field of Record #0 may identify Entry #2 associated with Error #3 and Record #0.

At 430, the stored information associated with Record #0 at Entry #2 is delivered to the software entity. At 435, Record #0 updates the validity field of the internal field. In one example, if no entry associated with Record #0 is available, the validity field is reset (e.g., set to ‘0’) to indicate that no error record is available associated with the integer register files. In one example, the value of the validity field is decremented to indicate the number of available entries.

At 440, a read operation is initiated. A software entity accesses Record #1 to obtain error records associated with floating point register files. Record #1 may provide error records stored at the static location of Record #1 associated with Error #1. The validity field of the internal field may determine that an error event (or two error events) is recorded associated with floating point register files. The internal field of Record #1 may determine Entry #0 associated with Error #1 and Record #1.

At 445, the stored information associated with Record #1 at Entry #0 is delivered to the software entity. Read operation may update the status field of Record #1. In one example, the read operation determines that another entry associated with Record #1 is available and does not change the validity field to indicate that an error record is available associated with the floating point register files. In one example, the value of the validity field is decremented to indicate the number of available entries.

At 450, a read operation, based on the validity field, may determine that another error record is available associated with Record #1 and continue obtaining the next error record. Record #1 may provide error records stored at the static location of Record #0 associated with Error #2. The validity field of the internal field may determine that an error event associated with floating point register files is recorded. The EIP field of the internal field of Record #1 may determine whether Entry #1 is associated with Error #2 and Record #1.

At 455, the stored information associated with Record #1 at Entry #1 is delivered to the software entity. At 460, Record #1 updates the validity field. In one example, if no entry associated with Record #1 is available, the validity field is reset (e.g., set to ‘0’) to indicate that no error record is available associated with the integer register files. In one example, the value of the validity field is decremented to indicate the number of available entries.

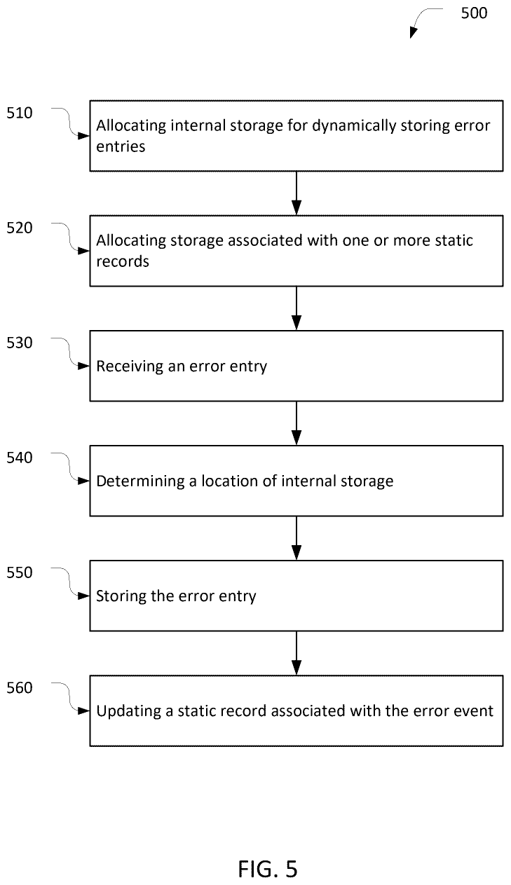

FIG. 5 illustrates a flow diagram in accordance with some embodiments. The flow diagram 500 may be performed or implemented by a compute system such as, for example, the compute system 100, multi-chip package 600, or system 700; or components thereof, for example, central processing unit (CPU) 640, graphics processing unit (GPU) 650, or processors 710.

The flow diagram 500 may include, at 510, allocating internal storage for dynamically storing error entries. Compute system 100 may determine and allocate internal storage for storing error entries. The internal storage may include one or more registers of compute system 100. Each entry may include one or more fields. One field may be an address field, one field may be an information field, and one field may be a timestamp field.

The flow diagram 500 may include, at 520, allocating storage for statically storing one or more records. Each stored record may be associated with a hardware structure of an integrated circuit. Each record may include a control field, a status field, or an internal field. The internal field may include an AIP, an EIP, or a validity subfield.

A header (e.g., header 340 in FIG. 3) may keep the information associated with the location of the storage allocated for storing one or more records. The header may include information such as the records identifier or the size of the storage (e.g., in terms of the number of records).

The flow diagram 500 may include, at 530, receiving an error entry. The error entry may be generated based on a detected error event associated with a hardware structure of an operation associated with the hardware structure. The error entry may include information associated with the error event, e.g., the hardware structure identifier, the severity of the error event, an identifier of the error type, a timestamp, or other details associated with the error event.

The flow diagram 500 may include, at 540, determining the location of the internal storage. The location may be allocated for storing an entry.

The flow diagram 500 may include, at 550, storing the error entry in the location.

The flow diagram 500 may include, at 560, updating a record of one or more records. In one example, the hardware structure associated with the error event may determine an error record. The EIP field of the internal field of the record may be updated to include the address of the stored error entry. Storing the address of the error entry in the EIP field of the record may create an association between the error entry and the record.

In some embodiments, the internal storage may be full. When the internal storage is full, the new entry may overwrite an older stored entry. The write operation may determine the location of the older entry and store the new entry in the identified location.

In some embodiments, a read operation may be initiated by an entity, e.g., a software entity. The AIP field of the record may determine that the record is being accessed, and the EIP field of the record may determine the location of the corresponding error entry. The error entry can be read by obtaining the content of the stored error entry.

In one example, the AIP field may indicate that the record is not being accessed. The read operation may determine the hardware structure associated with the record. The read operation may search the internal storage to identify one or more entries associated with the hardware structure. The read operation may read the error entry of the identified one or more entries with the lowest timestamp (e.g., the oldest error entry).

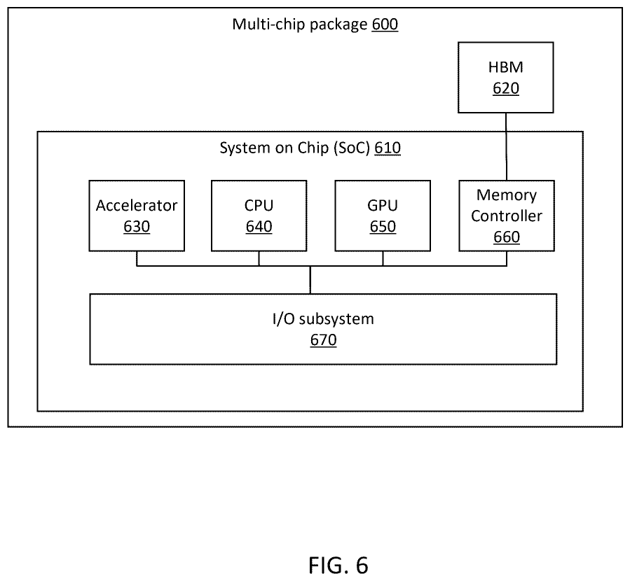

FIG. 6 is a diagram of an embodiment of a multi-chip package (MCP) 600 in accordance with some embodiments. MCP 600 can correspond to a computing device including, but not limited to, a server, a workstation computer, a desktop computer, a laptop computer, a hand-held device such as a smartphone, or a tablet computer. MCP may include packaging multiple integrated circuits (ICs) within a single package. MCP 600 may include a system-on-chip (SoC) 610 and a high-bandwidth memory (HBM) stack 620.

HBM 620 may provide high bandwidth throughput and low power consumption. HBM 620 may employ a large number of data channels to transfer data simultaneously. HBM 620 may stack multiple memory dies vertically, connected by through-silicon vias (TSVs), allowing for a greater density of memory cells and efficient use of space. The three-dimensional (3D) stacking increases the memory capacity and data transfer rates between the memory layer and the processors within the MCP 600.

SoC 610 can integrate components of a computing system into a single chip. SoC 610 may include one or more of an accelerator 630, at least one Central Processing Unit (CPU) 640, a Graphics Processor Unit (GPU) 650, a memory controller 660, or an input/output (I/O) system 670. Components of SoC 610 may be communicatively coupled with one another or other components of the MCP 600.

Accelerator 630 can include hardware or software components designed to perform specific computational tasks more efficiently than a general processor such as CPU 630. Accelerator 630 may offload and expedite particular functions from being executed by CPU 640. Digital signal processors (DSPs) for audio and communication signal processing or neural network accelerators for artificial intelligence and machine learning workloads are instances of accelerators 630.

CPU 640 is an example of a general-purpose CPU designed to perform fundamental functions such as executing arithmetic, logic, control, or input/output operations. CPU 640 may operate in conjunction with other components such as GPU 650, accelerator 620, memory controller 660, or I/O system 670.

CPU 640 may correspond to a single-core or a multi-core general-purpose processor. In one example, CPU 640 can include multiple cores, where each core includes one or more instruction and data caches, execution units, prefetch buffers, instruction queues, branch address calculation units, instruction decoders, or floating point units.

GPU 650 may be a specialized processor for handling tasks related to rendering and processing images or videos. GPU 650 can include one or more GPU cores. In one example, GPU cores may include one or more execution units and one or more instruction and data caches.

SoC 610 can also include one or more memory controllers 660. The memory controller 660 is communicatively coupled with memory and other components of the SoC 610, such as accelerator 630, CPU 640, or GPU 650. Memory controller 660 can include circuitry for accessing and controlling memory devices, such as memory dies, in the HBM stacks 620.

SoC 610 can include a memory controller 660. Memory controller 660 is communicatively coupled with memory and other components of the MCP 600, such as accelerator 630, CPU 640, or GPU 650. The memory controller includes circuitry for accessing and controlling memory devices, such as memory dies in HBM stacks 620. Memory controller 660 may be responsible for managing the flow of data between MCP 600 and the memory. The flow of data may include reading and writing of data by the MCP 600 to and from the memory.

The I/O subsystem 670 may include one or more I/O adapters to translate a host communication protocol utilized within the processor core(s) to a protocol compatible with particular I/O devices. Examples of protocols include Peripheral Component Interconnect (PCI)-Express (PCIe), Universal Serial Bus (USB), Serial Advanced Technology Attachment (SATA), and Institute of Electrical and Electronics Engineers (IEEE) 1594 “Firewire.”

In one example, the I/O subsystem 670 can communicate with external I/O devices, which can include, for example, user interface device(s) including a display or a touch-screen display, printer, keypad, keyboard, communication logic, wired or wireless, storage device(s) including hard disk drives (“HDD”), solid-state drives (“SSD”), removable storage media, Digital Video Disk (DVD) drive, Compact Disk (CD) drive, Redundant Array of Independent Disks (RAID), tape drive or other storage device.

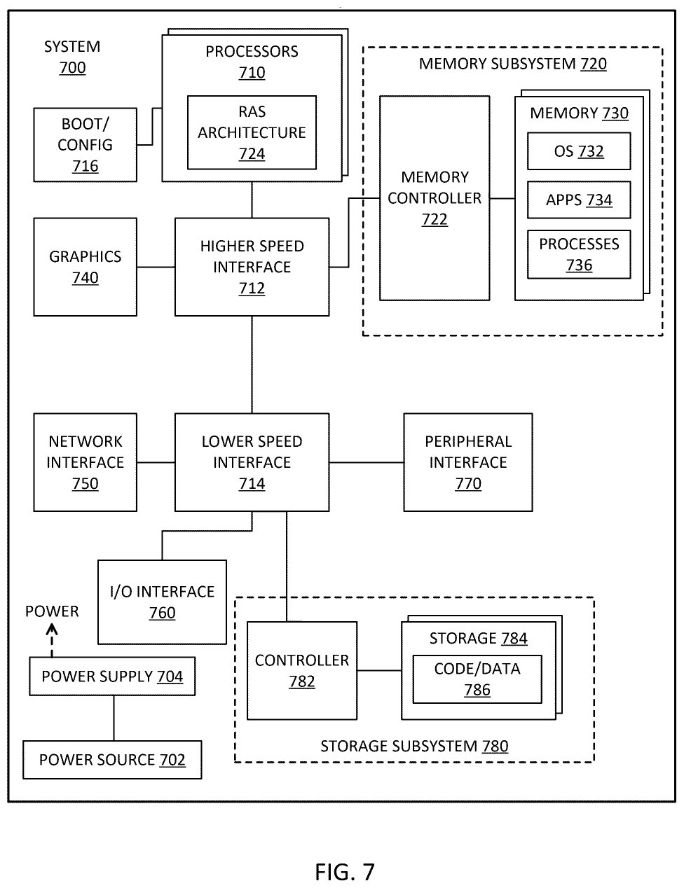

FIG. 7 is a block diagram of an example of a computing system in accordance with some embodiments. System 700 represents a computing device in accordance with any example herein and can be a laptop computer, a desktop computer, a tablet computer, a server, a gaming or entertainment control system, an embedded computing device, or other electronic devices.

In one example, system 700 includes RAS architecture 724, implementing semi-static allocation for error recording and retrieval in accordance with some embodiments. In one example, RAS architecture 724 includes internal storage to dynamically store error entries and storage to statically store error records.

System 700 includes processor 710. Processor 710 can include any type of microprocessor, central processing unit (CPU), graphics processing unit (GPU), processing core, or other processing hardware, or a combination, to provide processing or execution of instructions for system 700. Processor 710 can be a host processor device. Processor 710 controls the overall operation of system 700 and can be or include one or more programmable general-purpose or special-purpose microprocessors, digital signal processors (DSPs), programmable controllers, application-specific integrated circuits (ASICs), programmable logic devices (PLDs), or a combination of such devices.

System 700 includes boot/config 716, which represents storage to store boot code (e.g., basic input/output system (BIOS)), configuration settings, security hardware (e.g., trusted platform module (TPM)), or other system-level hardware that operates outside of a host OS (operating system). Boot/config 716 can include a non-volatile storage device, such as read-only memory (ROM), flash memory, or other memory devices.

In one example, system 700 includes interface 712 coupled to processor 710, which can represent a higher speed interface or a high throughput interface for system components that need higher bandwidth connections, such as memory subsystem 720 or graphics interface components 740. Interface 712 represents an interface circuit, which can be a standalone component or integrated into a processor die. Interface 712 can be integrated as a circuit onto the processor die or integrated as a component on a system on a chip. Where present, the graphics interface 740 interfaces to graphics components to provide a visual display to a user of system 700. Graphics interface 740 can be a standalone component or integrated onto the processor die or system on a chip. In one example, the graphics interface 740 can drive a high-definition (HD) display or ultra-high definition (UHD) display that provides an output to a user. In one example, the display can include a touch-screen display. In one example, the graphics interface 740 generates a display based on data stored in memory 730 or based on operations executed by processor 710 or both.

Memory subsystem 720 represents the main memory of system 700 and provides storage for code to be executed by processor 710 or data values to be used in executing a routine. Memory subsystem 720 can include one or more varieties of random-access memory (RAM), such as DRAM, 3DXP (three-dimensional crosspoint), or other memory devices, or a combination of such devices. Memory 730 stores and hosts, among other things, operating system (OS) 732 to provide a software platform for executing instructions in system 700.

Additionally, applications 734 can execute on the software platform of OS 732 from memory 730. Applications 734 represent programs with their own operational logic to execute one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller that generates and issues commands to memory 730. It will be understood that the memory controller 722 could be a physical part of processor 710 or a physical part of interface 712. For example, memory controller 722 can be an integrated memory controller integrated onto a circuit with processor 710, such as integrated onto the processor die or a system on a chip.

While not explicitly illustrated, it will be understood that system 700 can include one or more buses or bus systems between devices, such as a memory bus, a graphics bus, interface buses, or others. Buses or other signal lines can communicatively or electrically couple components together or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or other buses, or a combination.

In one example, system 700 includes interface 714, which can be coupled to interface 712. Interface 714 can be a lower-speed interface than interface 712. In one example, interface 714 represents an interface circuit, which can include standalone components and integrated circuitry. In one example, multiple user interface components, peripheral components, or both are coupled to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can exchange data with a remote device, which can include sending data stored in memory or receiving data stored in memory.

In one example, system 700 includes one or more input/output (I/O) interface(s) 760. I/O interface 760 can include one or more interface components through which a user interacts with system 700 (e.g., audio, alphanumeric, tactile/touch, or other interfacings). Peripheral interface 770 can include any hardware interface not specifically mentioned above. Peripherals generally refer to devices that connect dependently to system 700. A dependent connection is one where system 700 provides the software platform or hardware platform or both on which operation executes and with which a user interacts.

In one example, system 700 includes storage subsystem 780 to store data in a non-volatile manner. In one example, in certain system implementations, at least certain components of storage 780 can overlap with components of memory subsystem 720. Storage subsystem 780 includes a storage device(s) 784, which can be or include any conventional medium for storing large amounts of data in a non-volatile manner, such as one or more magnetic, solid state, NAND, 3DXP, or optical-based disks, or a combination. Storage 784 holds code or instructions and data 786 in a persistent state (i.e., the value is retained despite interruption of power to system 700). Storage 784 can be generically considered to be “memory,” although memory 730 is typically the executing or operating memory to provide instructions to processor 710. Whereas storage 784 is non-volatile, memory 730 can include volatile memory (i.e., the value or state of the data is indeterminate if power is interrupted to system 700). In one example, storage subsystem 780 includes controller 782 to interface with storage 784. In one example, controller 782 is a physical part of interface 714 or processor 710 or can include circuits or logic in both processor 710 and interface 714.

Power source 702 provides power to the components of system 700. More specifically, power source 702 typically interfaces to one or multiple power supplies 704 in system 700 to provide power to the components of system 700. In one example, power supply 704 includes an AC to DC (alternating current to direct current) adapter to plug into a wall outlet. Such AC power can be renewable energy (e.g., solar power) power source 702. In one example, power source 702 includes a DC power source, such as an external AC to DC converter. In one example, power source 702 or power supply 704 includes wireless charging hardware to charge via proximity to a charging field. In one example, power source 702 can include an internal battery or fuel cell source.

### EXAMPLES

In the following sections, further exemplary embodiments are provided.

Example 1 includes a method including: allocating first storage for dynamically storing error entries; allocating second storage for statically storing one or more records, wherein each record of the one or more records is associated with a hardware structure of one or more hardware structures of an integrated circuit; receiving an error entry associated with an error event of a hardware structure of the one or more hardware structures; storing the error entry in a location of the first storage; and updating a record of the one or more records, wherein the record is associated with the error event.

Example 2 includes the method of example 1 or some other examples herein, wherein: each stored error entry includes: an address field; an information field; and a timestamp field; and each record includes; a control field; a status field; and an internal field.

Example 3 includes the method of examples 1 or 2 or some other examples herein, wherein the internal field includes: an access in progress (AIP) field; an entry in progress (EIP) field; and a validity field.

Example 4 includes the method of any of examples 1-3 or some other examples herein, wherein the error entry is a first error entry, and said determining a location of the internal storage includes: determining that the internal storage is full; and determining the location to be the location of a second entry stored in the internal storage.

Example 5 includes the method of any of examples 1-4 wherein said storing the error entry in the location includes: overwriting the second entry.

Example 6 includes the method of any of examples 1-5 wherein the error entry is a first error entry, and said determining a location of the internal storage includes: determining that the internal storage is not full; and determining an available location in the internal storage.

Example 7 includes the method of any of examples 1-6 further includes: receiving a read associated with the record; and performing a read operation.

Example 8 includes the method of any of examples 1-7 wherein said performing a read operation includes: determining, based on an access in progress (AIP) field of the record, that the record is being accessed; identifying an entry in progress (EIP) field of the record indicating the location of the error entry; and reading the error entry.

Example 9 includes the method of any of examples 1-8 wherein said performing a read operation includes: determining, based on an access in progress (AIP) field of the record, that the record is not being accessed; identifying the hardware structure associated with the record; searching the internal storage to identify one or more error entries associated with the hardware structure; determining that the error entry has a lowest timestamp among the one or more error entries; and reading the error entry.

Example 10 includes the method of any of examples 1-9 wherein the error entry is a first error entry, and the method further includes: determining, based on a valid field of the record, that a second error entry associated with the record is available in the internal storage; and performing a read operation to read the second error entry.

Another example may include an apparatus comprising means to perform one or more elements of a method described in or related to any of examples 1-10 or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-10, or any other method or process described herein.

Another example may include an apparatus comprising logic, modules, or circuitry to perform one or more elements of a method described in or related to any of examples 1-10 or any other method or process described herein.

Another example may include a method, technique, or process as described in or related to any of examples 1-10, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-10, or portions thereof.

Another example may include an electromagnetic signal carrying computer-readable instructions, wherein execution of the computer-readable instructions by one or more processors is to cause the one or more processors to perform the method, techniques, or process as described in or related to any of examples 1-10, or portions thereof.

Another example may include a computer program comprising instructions, wherein execution of the program by a processing element is to cause the processing element to carry out the method, techniques, or process as described in or related to any of examples 1-10, or portions thereof.

Another example may include a computing device for providing as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
allocating first storage for dynamically storing error entries;
allocating second storage for statically storing one or more records, wherein each record of the one or more records is associated with a hardware structure of one or more hardware structures of an integrated circuit;
receiving an error entry associated with an error event of a hardware structure of the one or more hardware structures;
storing the error entry in a location of the first storage; and
updating a record of the one or more records, wherein the record is associated with the hardware structure.

2. The method of claim 1, wherein:
each stored error entry includes:
an address field;
an information field; and
a timestamp field; and
each record includes;
a control field;
a status field; and
an internal field.

3. The method of claim 2, wherein the internal field includes
an access in progress (AIP) field;
an entry in progress (EIP) field; and
a validity field.

4. The method of claim 1, wherein the error entry is a first error entry, and the method further comprises:
determining that the first storage is full; and
determining the location to be the location of a second entry stored in the first storage.

5. The method of claim 4, wherein said storing the error entry in the location comprises:
overwriting the second entry.

6. The method of claim 1, wherein the error entry is a first error entry, and the method further comprises:
determining that the first storage is not full; and
determining an available location in the first storage.

7. The method of claim 1, further comprises:
receiving a read associated with the record; and
performing a read operation.

8. The method of claim 7, wherein said performing a read operation comprises:
determining, based on an access in progress (AIP) field of the record, that the record is being accessed;
identifying an entry in progress (EIP) field of the record indicating the location of the error entry; and
reading the error entry.

9. The method of claim 7, wherein said performing a read operation comprises:
determining, based on an access in progress (AIP) field of the record, that the record is not being accessed;
identifying the hardware structure associated with the record;
searching the first storage to identify one or more error entries associated with the hardware structure;
determining that the error entry has a lowest timestamp among the one or more error entries; and
reading the error entry.

10. The method of any of claim 9, wherein the error entry is a first error entry, and the method further comprises:
determining, based on a valid field of the record, that a second error entry associated with the record is available in the first storage; and
performing a read operation to read the second error entry.

11. An integrated circuit comprising:
a first storage; and
processing circuitry configured to:
allocate the first storage for dynamically storing error entries;
allocate second storage for statically storing one or more records, wherein each record of the one or more records is associated with a hardware structure of one or more hardware structures of an integrated circuit;
receive an error entry associated with an error event of a hardware structure of the one or more hardware structures;
store the error entry in a location of the first storage; and
update a record of the one or more records, wherein the record is associated with the hardware structure.

12. The integrated circuit of claim 11, wherein the processing circuitry is further to:
receive a read associated with the record; and
perform a read operation.

13. The integrated circuit of claim 12, wherein to perform a read operation the processing circuitry is to:
determine, based on an access in progress (AIP) field of the record, that the record is being accessed;
identify an entry in progress (EIP) field of the record indicating the location of the error entry; and
read the error entry.

14. The integrated circuit of claim 12, wherein to perform a read operation the processing circuitry is to:
determine, based on an access in progress (AIP) field of the record, that the record is not being accessed;
identify the hardware structure associated with the record;
search the first storage to identify one or more error entries associated with the hardware structure;
determine that the error entry has a lowest timestamp among the one or more error entries; and
read the error entry.

15. The integrated circuit of claim 13, wherein the error entry is a first error entry, and the processing circuitry is to:
determine, based on a valid field of the record, that a second error entry associated with the record is available in the first storage; and
perform a read operation to read the second error entry.

16. A computer system comprising:
a first storage;
a second storage; and
processing circuitry configured to:
allocate the first storage for dynamically storing error entries;
allocate the second storage for statically storing one or more records, wherein each record of the one or more records is associated with a hardware structure of one or more hardware structures of an integrated circuit;
receive an error entry associated with an error event of a hardware structure of the one or more hardware structures;
store the error entry in a location of the first storage; and
update a record of the one or more records, wherein the record is associated with the hardware structure.

17. The computer system of claim 16, wherein the processing circuitry is further to:
receive a read associated with the record; and
perform a read operation.

18. The integrated circuit of claim 17, wherein to perform a read operation the processing circuitry is to:
determine, based on an access in progress (AIP) field of the record, that the record is being accessed;
identify an entry in progress (EIP) field of the record indicating the location of the error entry; and
read the error entry.

19. The integrated circuit of claim 17, wherein to perform a read operation the processing circuitry is to:
determine, based on an access in progress (AIP) field of the record, that the record is not being accessed;
identify the hardware structure associated with the record;
search the first storage to identify one or more error entries associated with the hardware structure;
determine that the error entry has a lowest timestamp among the one or more error entries; and
read the error entry.

20. The integrated circuit of claim 18, wherein the error entry is a first error entry, and the processing circuitry is to:
determine, based on a valid field of the record, that a second error entry associated with the record is available in the first storage; and
perform a read operation to read the second error entry.
